(19) United States
(12) Patent Application Publication
(10) Pub. No.: US 2016/0115881 A1
(43) Pub. Date: Apr. 28, 2016

(54) FUEL MIXTURE CONTROL SYSTEM

(71) Applicant: Jason Green, Davie, FL (US)

(72) Inventor: Jason Green, Davie, FL (US)

(21) Appl. No.: 14/520,878

(22) Filed: Oct. 22, 2014

(51) Int. Cl. F02D 41/00

(52) U.S. Cl. CPC F02D 41/0027

(57) ABSTRACT

A control system operative to establish a coordinated mixture of gaseous and distillate fuels for a high capacity off-road vehicle equipped with a diesel-electric drive including a propel mode includes an electronic control unit and a gaseous control unit. The electronic control unit generates an auxiliary control signal which is determinative of a steadily increasing quantity of gaseous fuel to be included in an operative fuel mixture. Upon indication that one or more predetermined operating parameters have exceeded a threshold level, the electronic control unit generates auxiliary control signal which decreases the quantity of gaseous fuel and maintain the quantity of gaseous fuel to be included in the operative fuel mixture once the predetermined operating parameters return below the threshold level.

### BACKGROUND OF THE INVENTION

1. Field of the Invention

The invention is directed to systems and methods of introducing a coordinated mixture of fuels for use in combustion ignition engines, and specifically diesel engines used to power AC electric drive trains of off-highway mine haul trucks.

2. Description of the Related Art

Typically large, stationary engines as well as mobile engines used to power heavy duty industrial vehicles are powered by either direct drive diesel or diesel electric power trains frequently including a multiple horse power turbo charged operation.

Accordingly, it is well recognized that distillate fuels, specifically diesel, are used as the primary fuel source for such engines. Attempts to maximize the operational efficiency, while maintaining reasonable safety standards, have previously involved modified throttle control facilities. These attempts serve to diminish adverse effects of control mechanisms which may be potentially harmful to the engine operation and may also be at least generally uneconomical. Typical adverse effects include increased fuel consumption and wear on operative components. Therefore, many diesel engines are expected to accommodate various types of high capacity loads and provide maximum power for relatively significant periods of operation. As a result, many diesel engines are commonly operated at maximum or near maximum capacity resulting in an attempted maximum power delivery from the engine and consequent high rates of diesel consumption. It is generally recognized that the provision of a substantially rich fuel mixture in the cylinders of a diesel engine is necessary for providing maximum power when required. Such continued high capacity operation of the engine results not only in wear on the engine components, but also in high fuel consumption rates, lower operating efficiencies, more frequent oil changes and higher costs of operation.

Accordingly, there is a long recognized need for a fuel control system specifically intended for use with high capacity, variable or constant speed compression ignition engines that would allow the use of more efficient fueling methods using other commonly available fuel sources. Therefore, an improved fuel control system is proposed which is determinative of an effective and efficient operative fuel mixture comprised of a combination of gaseous and distillate fuels. More specifically, gaseous fuels can comprise a natural gas or other appropriate gaseous type fuels, wherein distillate fuel would typically include, but not be limited to diesel fuel.

Such a preferred and proposed fuel control system should be capable of regulating the composition of the operative fuel mixture on which the engine operates to include 100% distillate fuel, when the operating mode(s) thereof clearly indicate that the combination of gaseous and distillate fuels is not advantageous. Further, such a proposed fuel control system could have an included secondary function to act as a general safety system serving to monitor critical engine operating parameters. As a result, control facilities associated with such a preferred fuel control system should allow for discrete, user defined control and safety set points for various engine and/or fuel system parameters.

In order to enhance efficient operation of an engine it is known to use a mass air flow sensor to determine the mass flow rate of air entering an internal combustion engine. It is known that air changes its density as it expands and contracts with temperature and pressure. As a result, it has been found that the determination of mass air flow is more appropriate than volumetric flow sensors for accurately determining the quantity of intake air delivered to the combustion section of the engine.

In the proper operation of CI engines, other factors to be considered include, but are not limited to, the occurrence of engine knocking. Knocking is a common occurrence in diesel engines where fuel is injected into highly compressed air at the end of the compression stroke. There is a short lag between the fuel being injected and combustion starting. Typically there is a quantity of fuel in the combustion chamber which will be ignited first in areas of greater oxygen density prior to the combustion of the complete fuel charge. A sudden increase in pressure and temperature may cause what has been recognized as a distinctive diesel “knock” or “clatter”.

Yet another factor to be considered in the effective and efficient performance of CI engines is “flammability limits”. Flammability limits refer to the fact that mixtures of gaseous fuel and air will only burn if the fuel concentration lies within well defined limits. The terms “flammability limits” and “explosive limits” are used interchangeably and recognized flammability limits are typically determined experimentally. Maintaining a preferred combination of fuel and air in an explosive mixture is important in internal combustion engines specifically including, but not limited to, CI engines or diesel engines. In addition, it is important to maintain the air fuel mixture below “lower flammability limits” prior to the delivery of the air fuel mixture into the combustion chambers in order to avoid or restrict pre-ignition and resultant damage to the engine.

Another known characteristic of CI or diesel engines is the establishment of a single safety set point occurring at maximum load conditions of the engine. However, due to the fluctuation of engine performance in the variable range of loads at which the engine operates, the proposed improvement in the functionality of CI engines would be the establishment of a system capable of dynamic set point protection. More specifically, a proposed system which may be originally included or retrofitted into a diesel engine would be the inclusion of structural and operative features which allows the CI engine to operate on a variable mixture of gaseous and distillate fuel. Moreover, under such operating conditions dynamic set point protection would comprise the ability to monitor engine performance across a variable range of engine loads and in association therewith determine a plurality of discrete safety and control set point values. As such, the determination of safety and control set point values would result in either engine shut-off or a deactivation of a gaseous/distillate operative mode and a transition to a full distillate operative mode when the responding safety and/or control set points indicate that engine shut off and or 100% diesel mode operation is appropriate.

### SUMMARY OF THE INVENTION

This invention is directed to a fuel control system specifically comprising technology that allows for the safe and efficient use of a gaseous fuel such as, but not limited to, natural gas, in combination with a predetermined quantity of conventional distillate fuel, such as diesel fuel. As a result, the composition of an “operative fuel mixture” used to power an associated engine will, dependent on the operating modes and/or operating characteristics thereof, be either a combined mixture of gaseous fuel and distillate fuel or substantially entirely distillate fuel, absent any contribution of gaseous fuel.

Moreover, the fuel control system of the present invention incorporates “real time” measurement capabilities specifically, but not exclusively, of each of the gaseous fuel and distillate fuel and the operative fuel mixture. More specifically, metering technology appropriate to each of the gaseous and distillate fuels will be used to establish the percentage of gaseous fuel and diesel fuel contained in the composition of the operative fuel mixture. Such appropriate metering will also facilitate the tracking of the overall gaseous fuel and diesel fuel consumption.

Accordingly, the system of at least one preferred embodiment of the present invention includes both controlling and safety features, specifically adaptable for use with compression ignition engines (CI), of the type more fully described herein. It is to be noted that the term “operative fuel mixture” may, as set forth above, include a composition composed of both gaseous fuel and distillate fuel present in varying ratios. However, for purposes of clarity, the term “operative fuel mixture” may also specifically refer to a composition comprised substantially entirely of the distillate fuel. Therefore, and as set forth in greater detail hereinafter, the composition of the operative fuel mixture may best comprise both gaseous fuel and distillate fuel in predetermined quantities, wherein the ratio of the gaseous and distillate fuels may vary. It is again emphasized, that the term “gaseous fuel” is meant to include natural gas or other gaseous type fuels appropriate for engine operation. Similarly, the term “distillate fuel” refers primarily, but not exclusively, to a diesel fuel.

The system and assembly of the present invention allows operators of stationary engines, including electric power generators and/or vehicle mounted engines, to substantially reduce costs, extend run time and improve sustainability by substituting natural gas or other gaseous fuel for a portion of the distillate fuel, such as diesel fuel in predetermined ratios. As a result, safe use of a natural gas and other gaseous fuel is used in place of distillate fuel with the combined ratios of an “operative gas mixture” in the range of 50% to 70% of the engines total fuel requirement. Importantly, generators or other stationary engines converted with the system and assembly of the present invention exhibit diesel like performance in such critical areas as load acceptance, power output, stability and efficiency.

Additional advantages of the system and assembly of the present invention allow for the onsite conversion of stationary or mobile engines to natural gas and/or diesel fuel operation. The installation and/or conversion process utilizes components that are installed externally of the engine/generator in a manner which does not require any changes or modifications to the combustion section thereof. As such, OEM combustion section components including cylinders, pistons, fuel injectors and/or cylinder heads remain the same. By retaining the OEM diesel or distillate fuel system in its entirety, the operative and structural features of the present invention maintains the engines capability to operate solely on diesel fuel when such is needed based on the operational modes or operating characteristics of the engine.

Moreover, the present invention utilizes “pipe-line supplied gaseous fuel” at a positive pressure, generally in the range of 3 psi to 7 psi. Accordingly, gaseous fuel is added to the intake air of the combustion section of the engine, at a positive pressure, utilizing one or more unique mixing assemblies. In more specific terms, each of the one or more mixing assemblies includes an electronically controlled throttle body integrated with a fixed geometry, low restriction air gas mixture. In terms of the integrated features of the throttle body and corresponding air gas mixer, the air gas mixer comprises a housing wherein the throttle body is fixedly mounted on or connected directly to the housing of the corresponding air gas mixer, such as on the exterior thereof. In addition, at least a portion of the housing of the air gas mixer is disposed in and thereby may at least partially define a path of travel or flow line of intake air to the combustion section of the engine. Moreover, a dispensing nozzle is disposed within the interior of the housing in direct communication and/or aligned relation within the flow path of the intake air. Further, a delivery conduit is disposed on the interior of the housing of the air gas mixer in interconnecting, gaseous fuel delivering relation between the throttle body and the dispensing nozzle.

As indicated, the supply of gaseous fuel is maintained at a positive pressure and delivered from the fuel supply to the throttle body and eventually from the throttle body to the corresponding, integrated air gas mixer at such positive pressure. Therefore, the gaseous fuel supply, throttle body and integrated air gas mixer are cooperatively structured and collectively operative to deliver gaseous fuel in appropriate, variable quantities and under a positive pressure to the intake air of the combustion section of the engine. This may differ from conventional fuel systems, wherein fuel is not maintained under a positive pressure or “pushed” from a fuel delivery assembly into the flow path of intake air. Moreover, one advantageous feature of the positive pressure delivery of the gaseous fuel of the present invention comprises the ability to “predict” and/or more precisely control the quantity of gaseous fuel being delivered to the flow of intake air and to the combustion section of the engine. As a result the maximum amount of gaseous fuel, within predetermined limits or parameters, may be added to the gaseous and distillate fuel mixture of the operative fuel composition and thereby assure efficient operation of the engine without consuming an excessive amount of distillate fuel. Factors which may limit the delivery of the maximum quantity of gaseous fuel, as set forth above may include, but are not limited to, the occurrence of “knocking” in the engine, maintaining appropriate lower flammability limits, etc.

Further direct mounting or connection of the throttle body to the integrated air gas mixer provides an additional safety feature. More specifically, due to such an integrated structure, there will not be a collection of gaseous fuel in a connecting conduit or line, between throttle body and air gas mixer and/or intake air, which may exist in conventional fuel systems. Therefore, unlike conventional fuel delivery connections, the gaseous fuel of the present invention may be “pushed” under the aforementioned positive pressure from the throttle body directly into the air gas mixer.

Dependent on the structural and operative features of the engine and/or generator with which the system and included structure is utilized, a turbo charger may be disposed within one or more intake air flow paths to the combustion chamber. When one or more turbochargers are so utilized and installed, the integrated throttle body and air gas mixer are disposed in fluid communication with the corresponding flow path upstream of the turbocharger. In yet another preferred embodiment of the system and assembly of the present invention a plurality of mixing assemblies are utilized, wherein each mixing assembly comprises an integrated throttle body and air gas mixer. As set forth above, the structural integration of each of the throttle body and corresponding air gas mixer comprises the air gas mixer including a housing disposed at least partially within and thereby at least partially defining the intake air flow path to the combustion section of the engine. Further, each throttle body will be fixedly mounted on or directly connected to the corresponding, integrated air gas mixer, such as on the housing thereof, to at least partially define the integrated structure thereof. The result of this integrated structure will be the advantages and enhanced operative features, as set forth above. As also indicated, each of the throttle bodies are independently operable based on monitored data determined by the ECU. As a result, each of a plurality of integrated throttle bodies/air gas mixers may provide a different and variable gaseous fuel flow to a different intake air flow path and corresponding combustion cylinder of the combustion section of the engine. Therefore, each combustion cylinder associated with the engine/generator with which the system of the present invention is utilized, may receive a gaseous fuel and distillate fuel mixture which differs from one or more of the other cylinders, depending upon the operating characteristics of the engine. This allows for even greater efficiency in regulating output of the engine based on operating characteristics of the engine, as detected by the monitoring capabilities of the ECU. Such engine operating characteristics include, but are not limited to, fuel rates, exhaust gas temperatures, vibrations levels, manifold air temperatures, mass air flow, gas pressures, engine coolant temperature, engine RPM, compressor inlet pressures and/or manifold air pressures. Operational enhancement and versatility of the ECU is structured to sample each data input up to 50 times per second thereby insuring rapid detection and collection of anomalies.

Yet another preferred embodiment of the present invention is directed to a fuel control system operative to establish gaseous fuel input for a compression ignition (CI) or diesel engine which is powered by a variable mixture of gaseous and distillate fuels dependent, at least in part, on the operating characteristics or parameters of the CI engine. Moreover, this additional preferred embodiment includes an electronic control module (ECU), of the type generally described above and in greater detail herein. As such, the ECU is operative to determine and/or regulate a concentration of gaseous fuel added into the intake air which is then directed to the combustion section of the CI engine. In order to facilitate proper and more efficient operation of the CI engine, a mass air flow measuring assembly comprising at least one mass air flow (MAF) sensor. The at least one MAF sensor is disposed in monitoring relation to the flow of intake air and along the flow path thereof upstream of a throttle assembly, also to be described in greater detail herein after.

The at least one MAF sensor is operatively connected to the ECU and cooperatively structured therewith to transfer appropriate, predetermined data and/or data signals thereto. The data delivered from the MAF sensor to the ECU is indicative of mass flow rate of the intake air passing along the path of intake air flow to the combustion section of the engine. The at least one MAF sensor is preferred over other known or conventional volumetric flow sensors for determining the quantity of intake air due to its greater accuracy and/or dependency in certain applications and at least partially dependent on the use of the engine with which the one MAF sensor is combined. As will also be described in greater detail, this additional preferred embodiment defines the mass air flow measuring assembly as including the one MAF sensor comprising a “hot wire” MAF sensor. As utilized and applied, the hot-wire mass air flow sensor functions by heating a wire, which is suspended in the engines intake air, with an electric current. The wire's electrical resistance increases when the wire temperature increases. This in turn limits the electrical current flowing through the circuit. When intake air flows past the wire, the wire cools thereby decreasing its resistance, which in turn allows more current to flow through the circuit. The current flow through the circuit increases the wire's temperature until the resistance reaches equilibrium.

Accordingly, it may be determined that the operative current required to maintain the wire's temperature is proportional to the “mass air flow” over the heated wire. Moreover, the integrated electronic circuit associated with the hot-wire MAF sensor converts the measurement of current to a voltage signal which is then sent to the ECU. The voltage signal or data signal, as used herein, is thereby indicative of the mass air flow rate of the intake air which in turn will be determinative, within certain operational parameters of the engine, of the amount of gaseous fuel which is added to the intake air flow directed to the combustion section of the CI engine. Further with regard to these structural and operative features of the hot-wire MAF sensor, if air density increases due to pressure increase or temperature increase or temperature drop while the air volume remains constant, the denser air will remove more heat from the heated wire indicating a higher mass air flow. Therefore, unlike other related sensors the hot-wire MAF sensor responds directly to air density. As a result, the hot-wire sensor represents a distinctive and more efficient operative component of this preferred embodiment of the fuel control system as it is better suited to support the combustion process of a CI engine which operates on a variable mixture of gaseous and distillate fuels.

Further, it is to be noted that the aforementioned predetermined operating parameters of this preferred embodiment include, but are not limited to, a maximum gaseous fuel input into the intake air flow of 4.5% by volume of the quantity of intake air based on the determination by the mass flow rate of the intake air. Moreover, the 4.5% of gaseous fuel relative to intake air is also sufficient to maintain lower flammability limits of the air mass and gaseous fuel mixture prior to entering into the combustion chambers of the CI engine.

Additional predetermined operating parameters also include the restriction, reduction or prevention of engine knocking. More specifically, this preferred embodiment of the fuel control system of the present invention includes an engine knock sensor operatively connected to the ECU. Accordingly, when engine knocking is detected the predetermined operating parameters dictate that the input of gaseous fuel into the intake air flow is reduced to an amount which serves to eliminate or at a minimum significantly restrict the occurrence of engine knocking so as to prevent damage to the engine.

As also explained in greater detail, the “throttle assembly” used in the structure and operation of this embodiment of the fuel control system preferably comprises the “throttle body” associated with the aforementioned mixing assembly. Accordingly, the throttle assembly comprises and/or is at least partially defined by the structurally integrated throttle body and air gas mixer. Moreover, the integrated throttle body and air gas mixer is disposed and structured to dispose the throttle body in fluid communication with a positively pressured gaseous fuel supply. As a result, gaseous fuel is “pushed” under a positive pressure, to the integrated throttle body and air gas mixer and there through to the intake air flow, being directed to the combustion section of the CI engine.

Due to the fact that the gaseous fuel is delivered under a positive pressure from the gaseous fuel supply it can be more efficiently regulated by effectively “pushing” the gaseous fuel through the throttle body into the air gas mixer and therefrom directly into the intake air flow in specified quantities and/or volumes to accommodate delivery of gaseous fuel in the amounts no greater than the 4.5% by volume of intake air and/or controlled, lesser amounts to restrict engine knocking and other unwanted operating features associated with the CI engine.

Yet another preferred embodiment of the present invention is directed to a control system which includes and electronic control unit (ECU) programmed to define a plurality dynamic set points or set point values directly associated with a plurality of predetermined operating parameters. Moreover, the plurality of dynamic set points overcome recognized disadvantages associated with the operation and control of CI engines which typically utilize a single safety set point, when the engine is operating at maximum load conditions. Accordingly, the plurality of dynamic set points are operative to determine engine shut off when necessary. In the alternative at least some of the plurality of dynamic set points are associated with corresponding ones of the plurality of predetermined operating parameters of the engine such that there is a deactivation of a gaseous-distillate operative mode of the engine and a concurrent or immediately subsequent transition to a full-distillate operative mode. Also, it is emphasized herein that the plurality of dynamic set points are determined over a variable range of engine loads and are not limited to a single established set point or value occurring when the engine is operating under maximum load conditions.

Moreover, the plurality of dynamic set points may comprise a plurality of “safety” set points as well as a plurality of “control” set points. As indicated above, the establishment or recognition of one of a possible plurality of “safety” set points would result in an engine shut-off. In contrast, the recognition or establishment of one or more “control” set point values would result in a deactivation of operational mode of the engine which fueled by a combined mixture of gaseous fuel. In contrast, the recognition or establishment of a control set point would immediately or subsequently result in the transition to a full operational mode of the engine, wherein it operates on 100% distillate fuel.

Other features of this additional preferred embodiment of the present invention include the plurality of dynamic set points or set point value for the pre-determined operating parameters of the engine being referenced to a base line performance of the engine during a 100% distillate fuel operation mode. As such, predetermined operating parameters of the engine specifically include, but are not necessarily limited to, fuel rates, exhaust gas temperatures, vibration levels of the engine, manifold air temperatures, manifold air flow (MAF), gas pressure, engine coolant temperatures, engine RPM, compressor inlet pressures, and/or manifold air pressures (MAP).

Accordingly, this additional preferred embodiment of the present invention provides for a monitoring assembly structured to determine the aforementioned pre-determined operating parameters associated with the engine performance. In operation, a plurality of data channels direct corresponding data, relating to the pre-determined operating parameters of the engine, to the ECU for programming, processing and determinative action in terms of transition of the engine to a 100% distillate fuel operation or an engine shut-off. It is further noted that in the programming operation associated with the ECU, each of a plurality of data channels is sampled up to 50 times per second ensuring rapid detection and correction of anomalies associated with each of the aforementioned determined operating parameters of the engine.

Other features associated with the present invention including the subject additional preferred embodiment as well as the remaining embodiments set forth in detail herein is the ECU being compatible with J-1939. Moreover, as also set forth herein, the monitoring assembly is also capable of monitoring a number of engine parameters including mass air flow, engine power output, diesel fuel flow etc. to accomplish the preferred and efficient operational standard whether operating on a gaseous-distillate fuel combination or a 100% distillate fuel operative mode. Yet another preferred embodiment of the control system of the present invention comprises a monitoring assembly operatively disposed and structured to determine a predetermined plurality of operating parameters of the engine. In particular, the monitoring assembly includes a plurality of sensors, to be described in greater detail hereinafter, disposed and structured to monitor and determine a plurality of a preferred 3 predetermined operating parameters of the engine, independent of load conditions of the engine. As with the additional embodiments described herein, the control system comprises an electronic control unit (ECU) connected to the monitoring assembly and configured to interpretively process data from the monitoring assembly, wherein such data is associated with the plurality of three operating parameters being monitored. As such, the ECU is operative to establish an increased or maximum concentration of gaseous fuel in the variable fuel mixture serving to power the engine. Moreover, the concentration of gaseous fuel supplied to and comprising a portion of the variable fuel mixture will be in direct compliance with at least the monitored ones of the three predetermined operating parameters which the plurality of sensors associated with the monitoring assembly are associated.

Accordingly, the control system of this preferred embodiment of the present invention further comprises the monitoring assembly including at least one mass airflow (MAF) sensor disposed in monitoring relation to the intake air flow to a combustion section of the engine. In addition the monitoring assembly includes at least one temperature sensor disposed and structured to determine temperature of exhaust gases from the combustion section of the engine. Further, the monitoring assembly may include at least one knock sensor operatively disposed relative to the combustion section of the engine. As indicated, while the monitoring assembly of this embodiment of the present invention may include at least one of the aforementioned mass air flow sensors, exhaust gas temperature sensors and knock sensors, a preferred application of the control system, when in use, may include the monitoring assembly including a plurality of each of the (MAF) sensors, exhaust gas temperature sensors and knock sensors.

Therefore, in more specific terms the predetermined plurality of the preferred three operating parameters being monitored and determinative of the concentration of gaseous fuel in the variable fuel mixture comprise mass flow rate of intake air to the combustion section of the engine; temperature of exhaust gases from the combustion section and an occurrence of engine knock in the combustion section. Moreover, there are situations depending upon the specific application and/or engine characteristics where the ECU is operative to establish a preferred, increased and or maximum concentration of gaseous fuel in the variable fuel mixture when interpreting and processing two of the predetermined plurality of three operating parameters. Further, an additional factor to be considered is the avoidance of “lower flammable limits” (LFL) also commonly referred to as lower explosive limits. As a result, a throttle assembly of the present invention, as set forth above, may be operative in conjunction with the ECU to establish a “maximum” concentration of gaseous fuel input into the variable mixture of generally about 4.5% by volume of the mass flow rate of intake air to the combustion section. The possibility of pre-ignition and/or engine knock is reduced.

Certain modern haul trucks may be equipped with a communications network known as a vehicle bus, which can be wireless. Such vehicle busses are often of a standardized format, such as the SAE J1939 recommended practice, which can be utilized to monitor any number of engine operating, combustion, or safety parameters, such as manifold air temperature, fuel flow, exhaust temperature, cylinder pressure, engine vibration limits, etc. Furthermore, such vehicle busses are often operatively communicatively connected to engine control components, such as an ECU, or an engine fuel control as well.

Furthermore, certain modern haul trucks may be equipped with AC/Diesel electric drives whereby a diesel motor is operatively connected to, and used to power, AC electric traction motors in the wheels of the haul truck. The operating modes of such a vehicle can include different power configurations. For example, while loaded or unloaded in a dissent orientation, the vehicle may be capable of regenerative braking, whereby power is derived from the natural tendency of the vehicle to roll downhill. Thus, the diesel engine is not required to be operating in such a mode. While in a low or high idle with the vehicle stationary, the diesel engine may be used to power various systems of the vehicle, such as a hydraulically powered bucket. Therefore, power requirements are largely dictated by the use of the vehicle systems. In loaded and unloaded climb orientations, the diesel engine is utilized to power the AC traction motors and power requirements are dictated substantially by load and grade.

A final operating mode, in which the present invention finds an embodiment, is what is known as a “propel mode.” During propel mode, which typically occurs in loaded and unloaded zero grade orientations, the diesel engine is held at a constant RPM setting and power output from the diesel engine is directed to the AC traction motors to propel the vehicle. Equipped with a J1939 standard vehicle bus, the vehicle bus is capable of monitoring and, in conjunction with various systems of the vehicle, correcting various vehicle parameters to maintain the engine at a static RPM despite changes in, for example, intake air density, intake air temperature, engine load demands, fuel composition, and the like. As such, when the vehicle is disposed in a propel mode, whereby the vehicle bus is utilized to maintain a static RPM, the vehicle bus may be utilized to correspondingly alter the flow of distillate fuel as a supplementary amount of gaseous fuel is added, while maintaining the predetermined operating and safety parameters such as those described herein. By way of example, a given propel mode may be established at an engine speed of 1900 RPM. A gaseous control unit may begin to introduce gaseous fuel to the combustion section at an increasing rate. The J1939 vehicle bus will then detect the increased combustion characteristics and reduce the amount of distillate fuel accordingly. The gaseous control unit may continue to increase the amount of gaseous fuel until an upper limit is reached, for example, that “knock” begins to occur, whereby the fuel mixture begins to auto-ignite. At such a point, the gaseous fuel may then be decreased to within normal operating parameters and maintained until one or more ambient conditions change.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation in block diagram form of one operative component of the fuel control system of the present invention directed to an electronic control unit and its various capabilities as a participant in the operation of the fuel control system.

FIG. 2 is a schematic representation in block diagram form of operative steps associated with the electronic control unit.

FIG. 3 is a schematic representation in block diagram form of the operation and performance of recognition capabilities of the electronic control unit during the performance of the fuel control system of the present invention.

FIG. 4 is a schematic representation in block diagram form of the programming capabilities associated with the electronic control unit.

FIG. 5 is a schematic representation in block diagram form of operative features of the monitoring capabilities of the electronic control unit of the fuel control system of the present invention.

FIG. 6 is a schematic representation in block diagram form of one operative component of the fuel control system of the present invention directed to an electronic control unit and its various capabilities as a participant in the operation of the fuel control system.

Like reference numerals refer to like parts throughout the several views of the drawings.

### DETAILED DESCRIPTION OF THE PREFERRED EMBODIMENT

As schematically represented in the accompanying Figures, the present invention is directed to a control system operative to establish a coordinated mixture or more specifically an operative fuel mixture of combined gaseous fuel and distillate fuel or alternatively only distillate fuel dependent on operating modes and operating characteristics of a vehicle. In particular, the control system of the present invention is specifically adaptable for use with high capacity vehicles, such as, but not limited to locomotives, earth moving equipment such as bulldozers, front-end loaders and shovels, container handling equipment such as rubber tire gantry cranes and reach stackers, heavy duty trucks and buses, and preferably, off-road vehicles such as mine haul trucks.

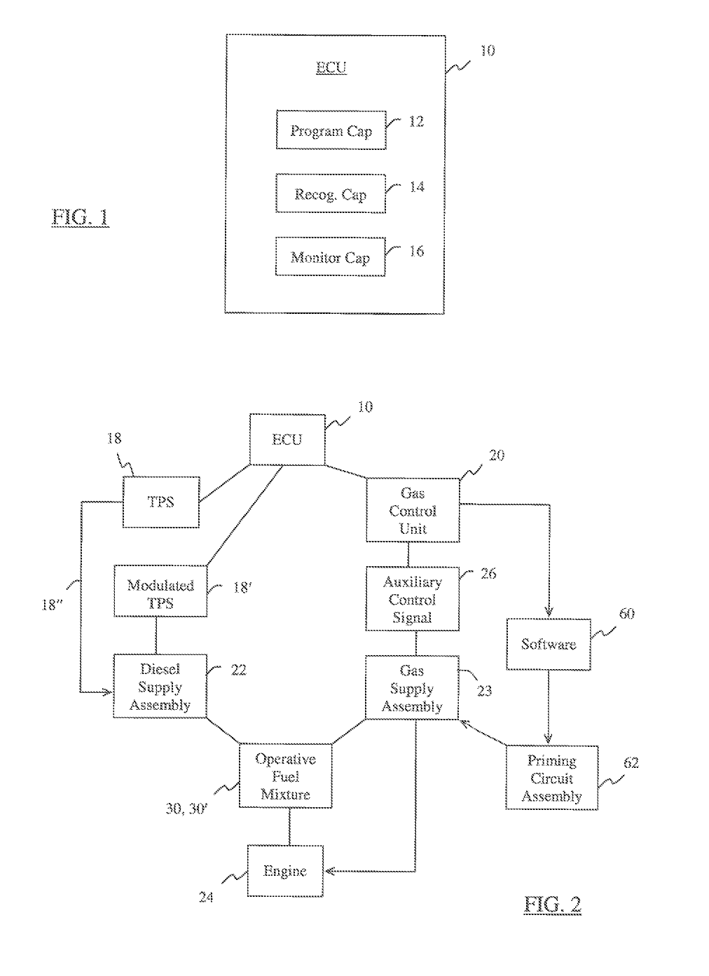

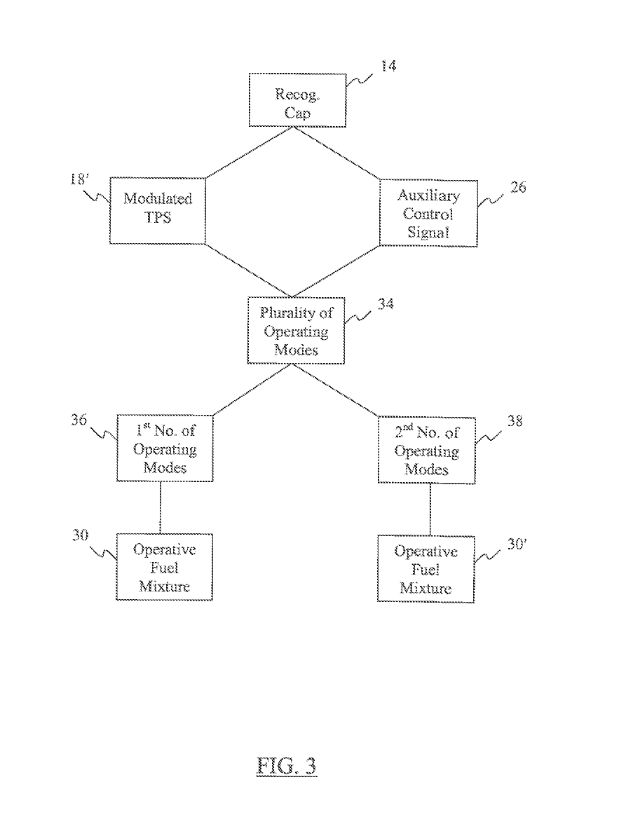

More specifically, the control system of the present invention comprises an electronic control unit 10 (ECU), which during practice and performance of the control system of the present invention demonstrates the operative features of its programming capabilities 12, recognition capabilities 14 and monitoring capabilities 16 as represented in FIG. 1. As represented in FIG. 2, the ECU 10 receives a throttle position signal 18 based on a “fly by wire” procedure incorporating an electronic interface. Moreover, the throttle position signal 18 is generated by the vehicle throttle assembly (throttle foot pedal) and dependent on the operating modes 34 and the operating characteristics 39 operative conditions of the vehicle and/or vehicle engine 24, may be delivered to the ECU 10 wherein the TPS 18 is modified, as at 18′ to establish an operative fuel mixture 30 which is composed of both distillate fuel and gaseous fuel, as explained in greater detail hereinafter. However, when the operating modes 34 of the vehicle and/or engine 24 dictate that the operative fuel composition 30′ is 100% distillate fuel, the TPS 18 will not be modified or modulated, as at 18″, and be transmitted to the diesel fuel supply assembly for delivery to the engine 24 in the form of an operative fuel composition 30′ which is composed of 100% diesel fuel.

It is emphasized the term “modulated” as used herein is meant to describe a modification of the originally generated TPS 18 received from the throttle pedal and is not meant to describe the generation of a “new signal form”. More specifically the modulated TPS signal 18′ represents a modification of the TPS 18 which informs the diesel supply assembly 22 that a lesser, predetermined percentage of the diesel fuel makes up a portion of the operative fuel mixture 30. Therefore the modulated TPS signal can be accurately described as a “predetermined percentage” of the original TPS signal 18, which is representative of the “percentage” of the diesel fuel contained in the operative fuel mixture 30. Accordingly, if the operating modes 34, 36 indicate that the operative fuel mixture should comprise both diesel and gaseous fuel mixture, the TPS 18 is “pulled” into the ECU 10 and modified to the extent that the modulated signal 18′ represents a percentage of the original TPS signal 18 sufficient to deliver the proper percentage of diesel fuel to the operative fuel mixture 30.

Accordingly, when the operating modes 34 of the vehicle/engine 24 comprise a first predetermined number of operating modes 36 the ECU 10 is operatively structured to modify or modulate the received throttle position signal 18, resulting in the generation of a “modulated throttle position signal” 18′ which is delivered to the gas (gaseous fuel) supply assembly 23. As operatively structured, the gas supply assembly 23 and gas control unit 20 determines the amount of gaseous fuel to be included in the operative fuel mixture 30 and the timing of delivery of the gaseous fuel delivered to the engine 24. As indicated herein, the operative fuel mixture 30 is composed of both diesel and gaseous fuel in predetermined quantities as it is delivered to the engine 24.

However, the fuel control system of the present invention also includes a gas control unit 20, which is disposed and structured for the delivery of a gaseous fuel source, such as natural gas. Further interaction between the ECU 10 and the gas control unit 20 will serve to generate an “auxiliary fuel control signal” 26 which is delivered to a gas supply assembly 23. It is of note that the modulated throttle position signal 18′ and the auxiliary fuel control signal 26 may be substantially concurrently delivered to the respective diesel supply assemble 22 and the gas supply assembly 23. As a result, the predetermined mixture of both gaseous fuel and distillate fuel results in the formation and delivery of the “operative fuel mixture” 30 to the engine 24 of the vehicle. Therefore, as indicated the modulated throttle position signal 18′ and the auxiliary fuel control signal 26 are collectively determinative of a quantity of gaseous fuel to be included in the operative fuel mixture 30 along with the appropriate quantity of distillate fuel. Once the operative fuel mixture 30 is determined, its delivery to the engine results in its current powering and operation, based in part on the operating modes and/or operating characteristics of the vehicle as explained in greater detail hereinafter.

With further reference to FIG. 2, it is recognized when the above noted composition of the operative fuel mixture 30 is utilized, the gaseous fuel does not “arrive” instantly. Therefore, a priming circuit assembly 62 is operatively associated with the gas control unit 20 and/or the gas supply assembly 23, as well as regulating software 60. Moreover, when the TPS 18 is being modified and the flow of diesel to the engine is stopped, the priming circuit assembly 62 is operative to direct a dedicated quantity of gaseous fuel to the engine, as at 64 independent of the gas supply assembly 23 being driven by the auxiliary control signal 26. The delivery of this dedicated quantity of gaseous fuel 63 will therefore compensate for the lag in fuel delivery to the engine 24.

As represented in FIG. 3 and as set forth above, the ECU 10 includes recognition capabilities 14. The recognition capabilities 14 are operative to regulate or restrict both the modulation of the throttle control signal or more specifically the modulated throttle control signal 18′ as well as the auxiliary control signal 26 dependent, at least in part, on a plurality of operating modes 34 of the vehicle. As relates to the high capacity, off road vehicle specifically including a mine haul truck, the plurality of operating modes include: low idle, vehicle at rest; high idle (dump mode), vehicle at rest; unloaded zero grade orientation; loaded zero grade orientation; unloaded climb orientation; loaded climb orientation; unloaded dissent orientation and loaded dissent orientation. However, it is further recognized that out of the above noted possible operating modes set forth above, a lesser “first predetermined number” of operating modes 36 is adaptive for the use of an operative fuel mixture 30 which comprises both gaseous fuel and distillate fuel.

Furthermore, the term “zero grade” is not merely limited to precisely zero grade orientations.

Accordingly, the first predetermined number of operating modes 36 comprise: the vehicle being unloaded on a zero grade; loaded on a zero grade; unloaded in a climb orientation and loaded in a climb orientation. As a result the remainder of the above outlined plurality of the operating modes 34 are defined by a “second predetermined number” of operating modes 38, which include: the vehicle being at low idle, vehicle at rest; high idle (dump mode), vehicle at rest; unloaded in a dissent orientation and loaded in a dissent orientation. Therefore, when the recognition capabilities 14 of the ECU 10 are operative to recognize the vehicle assuming any of the second plurality of operating modes 38, the result is a restriction or regulation of the modulation of the throttle position signal 18′ as well as the restriction or elimination of the generation of the auxiliary controls signal 26. In turn, the operative fuel mixture 30′ will be void of any gaseous fuel component as the vehicle operates in any one of the second predetermined number of operating modes 38.

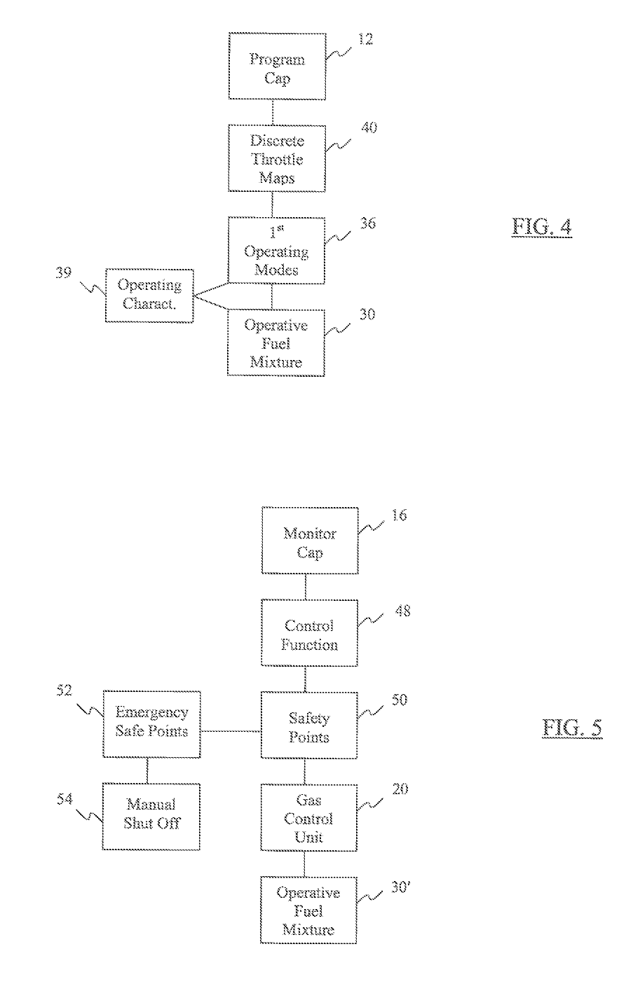

With primary reference to FIG. 4, the electronic control unit 10 further comprises the aforementioned programming capabilities 14 structured to establish a predetermined fuel composition of the operative fuel mixture 30, for vehicle operation during the first predetermined number of operating modes 36. More specifically, the programming capability 12 is operative allow a pre-selection of discrete throttle maps 40 for at least some or all of the first operating modes 36. Each of the discrete throttle maps 40 are defined by the operative fuel mixture 30 being composed of both gaseous fuel as well as distillate fuel, as the operative fuel mixture is delivered to the vehicle engine 24. Moreover, each of the discrete throttle maps 40 is preselected for maximizing efficiency of the vehicle engine 24 during a different one of the first predetermined number of operating modes 36. As such, each of the discrete throttle maps 40 is at least partially depended on prescribed combustion parameters of the vehicle engine.

Further with regard to FIG. 4, the ECU 10, including the recognition capabilities 14 associated therewith, are operative with the programming capabilities 12 to recognize “operating characteristics” 39 of the vehicle during the occurrence of at least some of the operating modes 36. For purposes of clarity and specifically relating to a high capacity off road vehicles specifically including mine haul trucks, the operating characteristics 39 comprise: the vehicle engine RPM; wheel speed; distillate throttle position signal; gaseous auxiliary control system and vehicle pitch and payload.

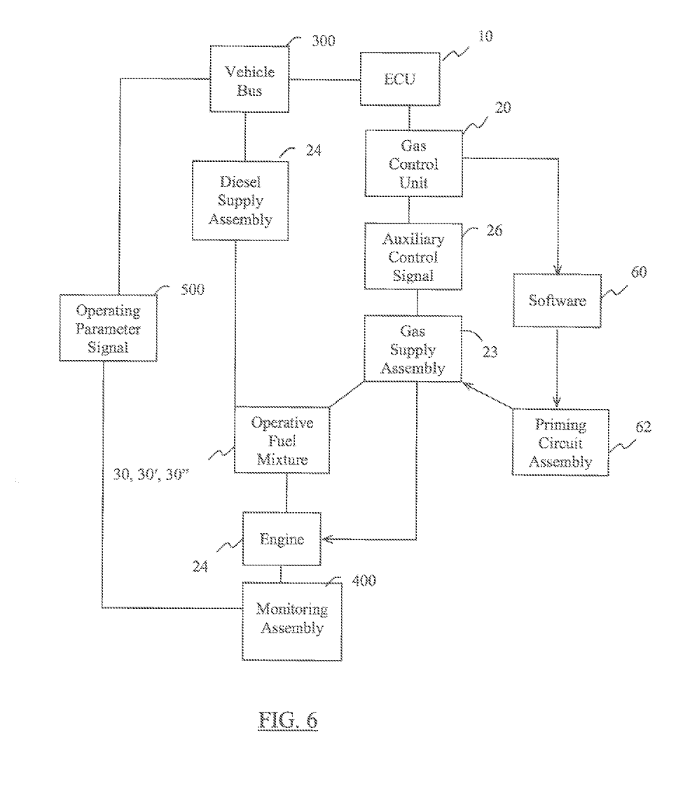

FIG. 5 is directed to the monitoring capabilities 16 which may be interactive with the fuel control system of the present invention such as by being integrated as part of the ECU 10, as indicated in FIG. 1, or as otherwise interactive therewith. The monitoring capabilities 16 are structured to monitor a plurality of predetermined vehicle safety set points 50 indicative of safe operation of the vehicle. Monitoring capabilities 16 include a control function 48 interactive with the gaseous control unit 20 to restrict or eliminate the contribution of gaseous fuel to the operative fuel mixture 30′. This will occur upon the monitoring capabilities 16 indicating or determining that the predetermined vehicle safety points 50 have been exceeded. During such an occurrence the operative fuel mixture 30′ is void of any gaseous fuel. Accordingly, the control function 48 is interactively operative with the monitoring capabilities 16 and is structured to negate both modulation of the throttle position signal 18′ and the generation of the auxiliary control signal 26 upon the occurrence of the predetermined safety set points 50 being exceeded. In addition to the general predetermined and/or preprogrammed safety features 50, at least a plurality of such safety features may be preprogrammed and set as emergency safety set points as at 52. As a result, the operator in the cab of the vehicle is provided access to a gaseous fuel supply shut off 54. The shut-off may be manually operated by occupants of the cab of the vehicle and responsive to determination by the monitoring capabilities of at least one of the emergency safety set points 52 of the vehicle. As set forth above, the manual shut-off is operative to override normally controlling capabilities and functionalities of the ECU 10.

In yet a further embodiment of the present invention, and with respect to FIG. 6, the operative features of the vehicle include a vehicle bus 300 or other communications network, which may be wired or wireless. An ECU 10 is disposed in communication with the vehicle bus 300 and furthermore configured, by way of programming, to ascertain whether the vehicle is operating in one or more of a plurality of operating modes 34. By way of example when the various systems and sensors of the vehicle indicate that it is traveling in a descent orientation under regenerative braking, with the diesel engine inoperative, then the ECU 10 may be configured to cease generating an auxiliary control signal 26. On the other hand, when the various systems and sensors of the vehicle indicate that it is traveling in a climb orientation, with the AC traction motors powered by the diesel engine, then the ECU 10 may be configured to operate as described above.

Yet the present embodiment is directed to another operating mode 34, wherein the vehicle is, loaded or unloaded, traveling on zero grade. In such an operating mode 34, the vehicle is configured to maintain the diesel engine at a static, predetermined engine speed. For example, as the power requirements of the vehicle on zero grade are substantially steady state, the engine speed may be predetermined to provide optimum efficiency for the required power output of the engine. Such an operating mode 34 may be commonly referred to as a “propel mode.” It should be appreciated that the term “zero grade” is not intend to be limited to precisely zero grade support surfaces, but may also include slight grades as well.

The ECU 10 is configured to recognize and/or detect when the vehicle is operating in such a propel mode. The ECU 10 is further configured to, upon such a detection, generate an auxiliary control signal 26 that is operative to steadily increase the amount of gaseous fuel comprising the operative fuel mixture 30. The resultant increase in gaseous fuel, without a corresponding decrease in distillate fuel, will generally increase the flammability or combustibility of the operative fuel mixture 30, provided that there is sufficient oxygen in the mixture as well. The increase in combustibility will generally serve to increase the engine speed of the diesel engine. However, due to the fact that the vehicle is operating in propel mode, the various systems and sensors of the vehicle will tend to maintain the engine speed at a predetermined RPM, and thus, take action to accomplish such. One method may be to “choke” or decrease the flow of oxygen to the operative fuel mixture 30. However, a preferred embodiment will include a diesel supply assembly 24 that is capable of decreasing the amount of distillate fuel comprising the operative fuel mixture 30 concurrent to the increase in gaseous fuel. By way of example, the diesel supply assembly 24 may be configured to reduce pressure in a fuel injector of the vehicle, or alternatively to decrease the fuel metering time of the fuel injector of the vehicle. The diesel supply assembly 24 is also capable of increasing the amount of distillate fuel comprising the operative fuel mixture 30 up to, and including 100% distillate fuel. Such increase in the amount of distillate fuel is of particular use when the ECU 10 generates an auxiliary control signal that is operative to decrease the amount of gaseous fuel included in the operative fuel mixture 30. Alternatively, an increase in distillate fuel may be desired dependent upon operating modes of the vehicle.

The vehicle bus 300 may also be in communication with a monitoring assembly 400 which can include any combination of a variety of sensors in order to monitor various combustion and/or safety parameters of the vehicle and/or engine which can comprise operating parameters. For example, the monitoring assembly may include one or more engine knock sensors which are operative to determine whether engine knock is occurring, for example, by detecting early or automatic ignition, or possibly excess or uncharacteristic engine vibration. Additionally the monitoring assembly may include one or more sensors equipped and configured to monitor fuel rates, exhaust gas temperatures, vibration levels of the engine, manifold air temperatures, mass air flow (MAF) rate, gas pressure, engine coolant temperatures, engine RPM, compressor inlet pressures, and/or manifold air pressures (MAP). Thus, the ECU 10, being in communication with the monitoring assembly 400, via the vehicle bus 300, is able to ascertain whether one or more threshold levels for any one of the predetermined operating parameters have been exceeded.

Accordingly, as the ECU 10 is configured to provide an auxiliary control signal 26 which steadily increases the amount of gaseous fuel to be included in the operative fuel mixture 30, the ECU 10 is also configured to continuously monitor an operating parameter signal 500 produced by the monitoring assembly as part of a feedback loop. The operating parameter signal includes data produced by the one or more sensors or sensor assemblies that can comprise the monitoring assembly 400. Once the ECU 10 establishes that any one or more of the predetermined operating parameters exceeds a threshold level, the ECU 10 then produces an auxiliary control signal 26 which is operative to decrease the amount of gaseous fuel included in the operative fuel mixture 30 until the one or more predetermined operating parameters no longer exceeds the threshold level. Such an operative fuel mixture 30 may be termed to be a dynamically determined operative fuel mixture 30″.

It will be appreciated that the precise composition of distillate and gaseous fuels that may comprise the dynamically determined operative fuel mixture 30″ can vary based on ambient conditions and quality of the fuels used. Thus the precise composition of dynamically determined operative fuel mixture 30″ is only determined once a threshold level of a predetermined operating parameter has been exceeded, and the operative fuel mixture 30 adjusted.

By way of example, when the monitoring assembly 400 includes an exhaust gas temperature sensor, the one or more operating parameters can include exhaust gas temperature. The threshold level of exhaust gas temperature may then be set or programmed to the ECU relative to the engine specification or may simply be set to a predetermined exhaust temperature point. By way of another example, when the monitoring assembly 400 includes an engine knock sensor, the one or more operating parameters can include engine knock. The threshold hold level of engine knock may then be set or programmed to the ECU as any amount of engine knock.

Additional operative features of the present embodiment, such as the operation of the gas control unit 20, should be understood to operate in a substantially similar fashion as described above. Additionally, the ECU 10 should be understood to include substantially the same operative features as described above such as, program capabilities 12, recognition capabilities 14, and monitoring capabilities 16, and furthermore, that these operative features function so as to maintain substantially the same operating characteristics and safety parameters as described above. Additionally, as described above, a maximum amount of gaseous fuel, within predetermined operating parameters, may still be added to operative fuel composition.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A control system operative to establish a coordinated mixture of gaseous and distillate fuels for a high capacity off-road vehicle equipped with a diesel-electric drive including a propel mode, comprising:
an electronic control unit;
a gaseous control unit;
said electronic control unit structured to generate and communicate an auxiliary control signal to said gaseous control unit dependent at least in part on operating modes of the vehicle, said auxiliary control signal determinative of a steadily increasing quantity of gaseous fuel to be included in an operative fuel mixture;
said electronic control unit further structured to receive an operating parameter signal from a vehicle bus, said operating parameter signal comprising data indicative of at least one predetermined operating parameter;
said electronic control unit further structured to generate and communicate an auxiliary control signal to said gaseous control unit upon said operating parameter signal indicating said at least one predetermined operating parameter has exceeded a threshold level, said auxiliary control signal determinative of a decreasing quantity of gaseous fuel to be included in said operative fuel mixture;
said electronic control unit further structured to generate and communicate an auxiliary control signal to gaseous control unit upon said operating parameter signal indicating said at least one predetermined operating parameter has return below said threshold level; said auxiliary control signal determinative of a steadily maintained quantity of gaseous fuel to be included in said operative fuel mixture.

2. A control system as recited in claim 1 further comprising a monitoring assembly operatively connected to the diesel engine and disposed in communicating relation with said vehicle bus; said monitoring system further configured to communicate said operating parameter signal to said vehicle bus.

3. A control system as recited in claim 2 wherein said monitoring system comprises at least one engine knock sensor; said operating parameter signal comprises data indicative of the presence of engine knock.

4. A control system as recited in claim 3 wherein said threshold level comprises any amount of engine knock.

5. A control system as recited in claim 2 wherein said monitoring system comprises at least one exhaust gas temperature sensor;
said operating parameter signal comprises data indicative of a temperature of exhaust gas of the diesel engine.

6. A control system as recited in claim 5 wherein said threshold level comprises a predetermined exhaust gas temperature

7. A control system as recited in 1 wherein said vehicle bus is configured to be compatible with SAE J1939 standard.

8. A control system as recited in claim 1 further comprising a diesel supply assembly capable of decreasing the amount of distillate fuel to be included in said operative fuel mixture concurrently to the increase in gaseous fuel thereto.

9. A control system as recited in claim 8 wherein said diesel supply assembly is further capable of increasing the amount of distillate fuel to be included in the operative fuel mixture, up to, and including, 100% distillate fuel.

10. A system as recited in claim 1 wherein said electronic control unit generates said auxiliary control signal substantially concurrently to a decreasing quantity of distillate fuel included in said operative fuel mixture.

11. A method of establishing a coordinated mixture of gaseous and distillate fuels for a high capacity off-road vehicle equipped with a diesel-electric drive including a propel mode, comprising:
providing an electronic control unit in communication with a vehicle bus and a gas control unit;
continuously monitoring at least one operating parameter signal communicated to the vehicle bus with the electronic control unit;
producing an auxiliary control signal with the electronic control unit that is operative to increase the amount of gaseous fuel to be included in an operative fuel mixture;
producing an auxiliary control signal with the electronic control unit that is operative to decrease the amount of gaseous fuel to be included in the operative fuel mixture substantially concurrently to the at least one predetermined operating parameter exceeding a threshold level;
producing an auxiliary control signal with the electronic control unit that is operative to maintain the amount of gaseous fuel to be included in the operative fuel mixture at a steady state substantially concurrently to the at least one predetermined operating parameter returning below the threshold level.

12. A method as recited in claim 11 wherein the at least one operating parameter signal comprises data indicative of the presence of engine knock.

13. A method as recited in claim 12 wherein the threshold level comprises any amount of engine knock.

14. A method as recited in claim 11 wherein the at least one operating parameter signal comprises data indicative of a temperature of exhaust gas of the diesel engine.

15. A method as recited in claim 14 wherein the threshold level comprises a predetermined exhaust gas temperature.
